(19) United States
(12) Patent Application Publication
(10) Pub. No.: US 2023/0349433 A1
(43) Pub. Date: Nov. 2, 2023

(54) HAPTIC BRAKING DEVICE AND PARALLEL HYBRID ACTUATOR SYSTEM USING SAME

(71) Applicant: Haply Robotics inc., Montreal (CA)

(72) Inventors: Antoine WEILL--DUFLOS, Montreal (CA); Maciej LACKI, Montreal (CA); Colin GALLACHER, Montreal (CA)

(21) Appl. No.: 18/140,920

(22) Filed: Apr. 28, 2023

Related U.S. Application Data
(60) Provisional application No. 63/337,348, filed on May 2, 2022.

(51) Int. Cl. F16D 57/00; G05G 5/03; H02K 7/00; H02K 7/14

(52) U.S. Cl. CPC F16D 57/002; G05G 5/03; H02K 7/003; H02K 7/14; G05G 2505/00

(57) ABSTRACT

Described are various embodiments of a haptic braking device and parallel hybrid actuator system using same. In one embodiment, the braking device comprises a fixed elongated shaft member having a first end directly or indirectly affixed to a non-rotating surface, the fixed elongated shaft member comprising a driving member coupled along a length thereof configured to drive a change a rheological property of a damping substance. A rotatable brake housing is configured to be rotationally coupled to a motor shaft via a transmission, comprises an elongated aperture defined within fittingly receiving said shaft member therethrough and configured to allow said housing to rotate around said shaft member. A channel defined within the housing filled with the damping substance is in physical contact with the shaft member and the driving member upon activation increases a frictional resistance to a rotational motion of the housing around said shaft member.

### CROSS-REFERENCE TO RELATED APPLICATIONS

This application claims the benefit of U.S. Provisional Application No. 63/337,348 filed May 2, 2022, which is incorporated herein by reference in its entirety.

### FIELD OF THE DISCLOSURE

The present disclosure relates to haptic devices, and in particular, to a haptic braking device and parallel hybrid actuator using same.

### BACKGROUND

A haptic device using exclusively motors as actuators is intrinsically unstable. Hybrid actuators improve properties of haptic devices as they provide better control over actuator characteristics. A hybrid actuator can consist of motors, brakes, springs, dampers and other mechanical components, connected in series or in parallel. For haptic applications it is common to use a motor and brake in parallel as this configuration allows both actuators to contribute to the torque output of the device. For the purposes of the present disclosure, there are two features of hybrid actuators that require closer examination, the anatomy of Magneto-rheological (MR) brakes which are a preferred type of brake in haptic devices, and the transmission amplifying the motor torque.

An MR brake uses MR fluid which changes viscosity when it is subjected to a magnetic field creating braking torque. Typically, the brake housing acts as a stator which contains a magnetic coil and circuitry required to generate the magnetic flux while the rotor transmits the torque. As a result, these brakes can generate high torques with small actuators.

However, the disproportionate amount of torque in the two actuators is not desirable. Typically, a transmission is added between the motor and the brake to amplify the torque of the motor. Belt or capstans transmissions are a preferred choice for these applications as they induce less inertia, friction, and backlash into the device at the expense of compactness. Capstan transmissions consist of two drums with different diameters, attached to the shafts of the actuators, and connected using a flexible cable. The ends of the cable are fixed to their respective drums and transmit the force from one drum to the other. Due to the difference in drum diameters, the torque is amplified.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a new type of haptic braking device, where the brake housing acts as rotor to be used in a parallel hybrid actuator comprising a brake, motor, and a transmission. The proposed parallel hybrid actuator uses the housing of the proposed brake as part of the transmission resulting in a simpler and more compact design.

In accordance with one aspect, there is provided a haptic braking device for use in a parallel hybrid actuator system, the haptic braking device comprising: a fixed elongated shaft member having a first end directly or indirectly affixed to a non-rotating surface, the fixed elongated shaft member comprising a driving member coupled along a length thereof configured to drive a change a rheological property of a damping substance; a rotatable brake housing, the housing comprising: an outer lateral surface configured to be rotationally coupled to a motor shaft via a transmission; an elongated aperture defined within said housing fittingly receiving said shaft member therethrough and configured to allow said housing to rotate around said shaft member; and one or more channels defined within said housing filled with said damping substance, the channels configured so that the damping substance is in physical contact with the shaft member and the driving member; and wherein upon said driving member being activated, the change in rheological property om the damping substance causing an increased frictional resistance to a rotational motion of the housing around said shaft member.

In one embodiment, the damping substance is a magneto-rheological (MR) fluid, and wherein said driving device comprises: a magnetic coil configured to, upon said activation, generate a magnetic field through said MR fluid, thereby causing an increase in a viscosity of said MR fluid and increasing said frictional resistance.

In one embodiment, the damping substance is an electro-rheological (ER) fluid, and wherein said driver device comprises: a plurality of spaced-apart electrically conductive parallel plates configured to generate, upon said activation, an electrical field through the ER fluid, thereby causing an increase in a viscosity of said ER fluid and increasing said frictional resistance.

In one embodiment, the damping substance is a free-flowing powder of magnetizable particles, and wherein said driving device comprises: a magnetic coil configured to, upon being activated, generate a magnetic field through said powder of magnetizable particles, thereby making the particles clump along magnetic field lines and increase said frictional resistance.

In one embodiment, the haptic braking device further comprises a power source for providing power to said damping portion upon said activation; and a controller comprising a processor and a memory, the controller operably coupled to said damping portion and configured to activate or deactivate said damping portion.

In one embodiment, the rotatable brake housing is cylindrically shaped.

In one embodiment, the transmission is a capstan transmission and wherein said outer lateral surface is configured to be coupled to a cable of said capstan transmission.

In one embodiment, the cable of the capstan transmission is further coupled to a capstan drum attached to said motor shaft.

In one embodiment, the transmission is a transmission chain, and wherein said outer lateral surface comprises a plurality of outwardly projecting teeth for engaging said chain.

In one embodiment, the transmission is a belt and wherein said outer lateral surface comprises a groove or recess for receiving said belt therein.

In one embodiment, the shaft member comprises: an elongated shaft body configured to be received within said elongated aperture; and an attachment portion coupled to said elongated shaft body and affixed to said non-rotating surface.

In one embodiment, the elongated shaft body and said attachment portion form a single piece.

In one embodiment, the elongated shaft body can be removably fastened to said attachment portion.

In accordance with another aspect, there is provided a parallel hybrid actuator system for providing haptic feedback, comprising: a motor affixed to a non-rotating surface at a first location, the motor comprising a motor shaft and configured to, upon activation, drive a rotation of the motor shaft; a braking device comprising: a fixed elongated shaft member having a first end directly or indirectly affixed to said non-rotating surface at a second location, the fixed elongated shaft member comprising a driving member coupled along a length thereof configured to drive a change a rheological property of a damping substance; a rotatable brake housing, the housing comprising: an elongated aperture defined within said brake housing fittingly receiving said fixed shaft member therethrough and configured to allow said brake housing to rotate around said fixed shaft member; and one or more channels defined within said housing filled with said damping substance, the channels configured so that the damping substance is in physical contact with the shaft member and the driving member; and a transmission for rotationally coupling the motor shaft to an outer lateral surface of said rotatable brake housing.

In one embodiment, the parallel hybrid actuator system further comprises a controller comprising a processor and a memory, the controller operably coupled to said motor and to said damping portion of the braking device and configured to control the activation of said motor and said damping portion to provide said haptic feedback.

In one embodiment, the parallel hybrid actuator system further comprises a handle member rotationally coupled to one of: the motor shaft, the transmission, or the rotatable break housing.

In one embodiment, the handle member is coupled to the rotatable brake housing.

In one embodiment, the handle member is coupled to the motor shaft.

In one embodiment, the transmission is a capstan transmission coupled to the motor shaft at one end thereof, and coupled to the brake housing at a second end thereof.

In one embodiment, the motor is a first motor of a plurality of motors, and said braking device is a first braking device of plurality of devices; and wherein each of said plurality of motors and said plurality of braking devices are rotationally coupled in parallel to one another via said transmission.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a schematic diagram illustrating a magneto-rheological (MR) brake as currently known in the art, in accordance with one embodiment;

FIG. 2 is a schematic diagram illustrating an improved MR brake comprising a rotatable brake housing, in accordance with one embodiment;

FIG. 3 is a side view of a parallel hybrid actuator system as currently known in the art, in accordance with one embodiment;

FIG. 4 is a side view of an improved parallel hybrid actuator system using an improved braking device, in accordance with one embodiment;

FIGS. 5A and 5B are a top view and side view, respectively, of an improved parallel hybrid actuator system configured to use a belt as a transmission, in accordance with one embodiment;

FIGS. 6A and 6B are a top view and a side view, respectively, of an improved parallel hybrid actuator system configured to use a chain as a transmission, in accordance with one embodiment;

FIGS. 7A and 7B are a top view and a side view, respectively, of an improved parallel hybrid actuator system configured to be rotatably coupled via gear teeth, in accordance with one embodiment;

FIGS. 8A and 8B are side views of the parallel hybrid actuator system of FIG. 4 coupled to a handle member via the rotatable housing or to the motor shaft, respectively, in accordance with one embodiment; and

FIG. 9 is a schematic diagram illustrating the parallel hybrid actuator system of FIG. 4 operably coupled to a controller, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

In accordance with different embodiments, a braking device and a parallel hybrid actuator system using same is disclosed. In some embodiments, the braking device, in accordance with different embodiments, comprises a rotatable housing configured to act as a rotor portion while the shaft is affixed and acts as the stator portion. Thus, during operation, the housing, and the elements within (e.g., braking mechanism, electronics, etc.) rotate around the shaft, which is affixed to the outer surface or ground. The braking device described herein may advantageously be incorporated into a parallel hybrid actuator system for haptic feedback applications, as will be discussed below. Such a hybrid actuator system, in turn, may rely on different types of transmissions, including for example a capstan transmission.

In addition, in some embodiments, the braking device may rely on various braking mechanisms or portions. This may include a damping portion housed within the brake housing, the damping portion mechanically coupled to the shaft and configured to, upon being activated, provide increased frictional resistance to a rotational motion of the housing around the shaft member. In some embodiments, the damping portion or braking mechanism may comprise a damping substance having controllable rheological properties to provide the damping. This may include a MR fluid, but also an electro rheological (ER) fluid or even free-flowing powder of magnetizable particle (e.g., as in a particle brake or the like).

In some embodiments, the modifications or improvements to the configuration of a parallel hybrid actuator described herein, the hybrid actuator comprising an improved braking device, coupled to a motor via a transmission system, provides a system that is more compact by using the new configuration of a braking device (e.g., an MR brake or other) is described. By making the housing of the brake the rotor that acts also as an output shaft, the brake can be used as part of the transmission. This advantageously reduces the size and number of parts in the hybrid actuator.

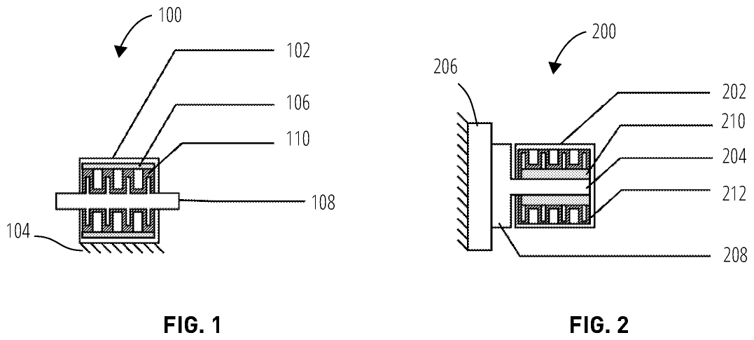

FIG. 1 shows a conventional haptic braking device 100 where the brake housing 102 is fixed to the ground or fixed surface 104 (e.g., acting as the stator). In the illustrated example, wherein the braking device is a MR brake, the magnetic coil 106 of the brake is in the same inertial frame as the brake housing 102. The brake rotor 108 exits the casing 102 transmitting the torque. The MR fluid 110 acts like a fluid and generates low torque in absence of magnetic field. When a magnetic field is applied the fluid changes its viscosity, increasing the shearing forces acting on the rotor 108.

FIG. 2 shows an improved new brake design or braking device 200, where the brake housing 202 acts as the rotor, while the stator shaft 204 is fixed to the ground or fixed surface 206 (for example via a brake attachment 208). In this example, the braking device is also implemented as a MR brake and thus includes the magnetic coils 210 and the MR fluid 212. The magnetic coils 210 of the braking device 200 is in the same inertial frame as the shaft 204 (e.g., do not rotate). In some embodiments, the shaft 204 and the brake attachment 208 may form a single piece, while other embodiments may have the shaft 204 removably fastened to the brake attachment 208. Different means to removably fasten the shaft to the brake attachment 208 may be considered, as will be understood by the skilled person in the art, without limitation, including for example the shaft 204 at one end comprising a threaded end configured to engage a correspondingly shaped aperture in the brake attachment 208.

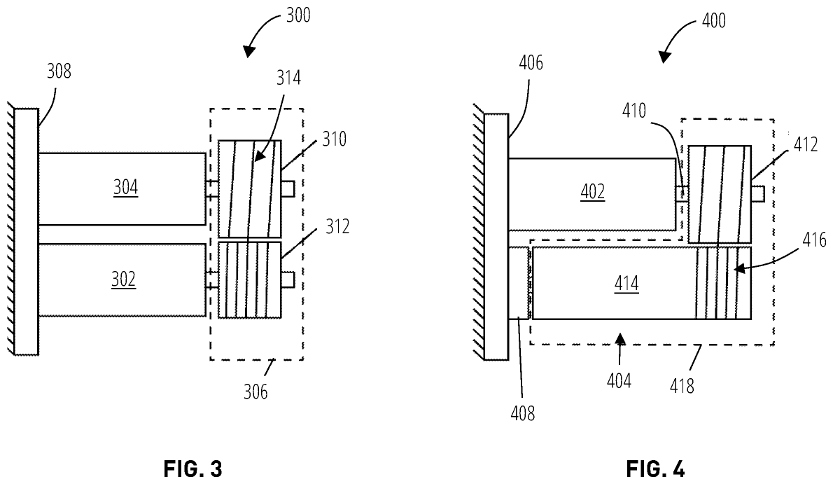

FIG. 3 shows a typical design of a parallel hybrid actuator 300 comprising a brake 302, a motor 304, and a capstan transmission 306. Both the brake and the motor housings are fixed to the ground 308 and their shafts are equipped with differently sized cylinders (e.g., capstan drums) 310 and 312, connected with a flexible cable 314. The difference in the cylinder size creates a mechanical advantage that increases the torque of the motor 304.

FIG. 4 shows the improved hybrid actuator system 400 where the housing of the motor 402 and shaft of the braking device 404 are fixed to the ground 406 (via the brake attachment 408). The motor shaft 410 is equipped with a cylinder 412 which is connected to the brake housing 414 using the flexible cable 416 creating a mechanical advantage. In the example of FIG. 4, which uses a capstan transmission, the brake housing 402 is a smooth cylinder, and by being coupled to the motor shaft thus forms also part of the transmission system 418. However, as will be discussed further below, other embodiments may have the housing 402 shaped to accommodate other types of transmissions. In some embodiments, the transmission for haptic applications can use ER and Particle brakes in place of MR brakes. In some embodiments, an outrunner motor could be used with a standard MR brake. In some embodiments, the cylinders or drums comprising the capstan may be optional. If the shafts of the two actuators have different diameters, no cylinder is required.

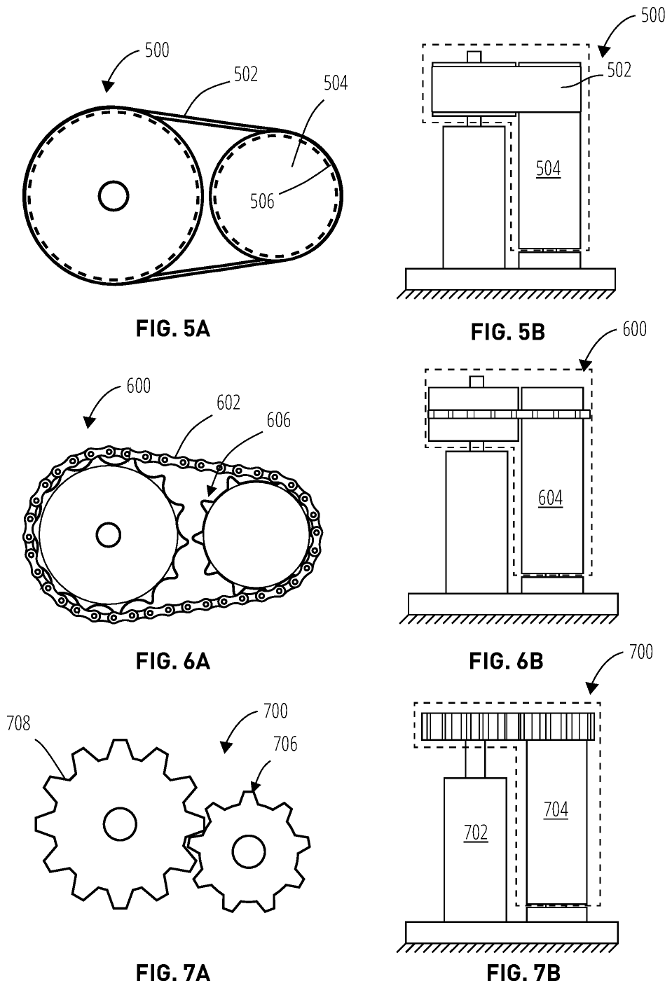

In some embodiments, for haptic applications, the mechanism may preferably use capstan transmissions, but the mechanism described herein may also work with a belt drive, or gears, where the brake housing would be shaped or an outer attachment with gears. FIGS. 5A-B, 6A-B, and 7A-B illustrate other such examples of transmissions that may be used with the hybrid actuator system. FIGS. 5A and 5B show a hybrid actuator system 500 using a belt 502. In this example, the brake housing 504 comprises a recess or channel along its circumference (illustrated by the dashed lines 506) configured to securely receive the belt 502 therein, and prevent the belt from slipping during use.

FIGS. 6A and 6B show a hybrid actuator system 600 using a chain 602, in accordance with one embodiment. In this example, the brake housing 604 comprises a plurality of laterally outwardly projecting teeth 606 configured to fittingly engage the links of the chain 602. FIGS. 7A and 7B show a hybrid actuator system 700 having the motor 702 and brake housing 704 coupled via a gear mechanism. In this example, the brake housing 704 comprises a plurality of laterally outwardly projecting gear teeth 706 configured to engage a corresponding gear 708 coupled to the motor 702. The skilled person in the will appreciate that the examples above are non-limiting, and that any other means of coupling the motor and the braking device known in the art may be used as well, without limitation.

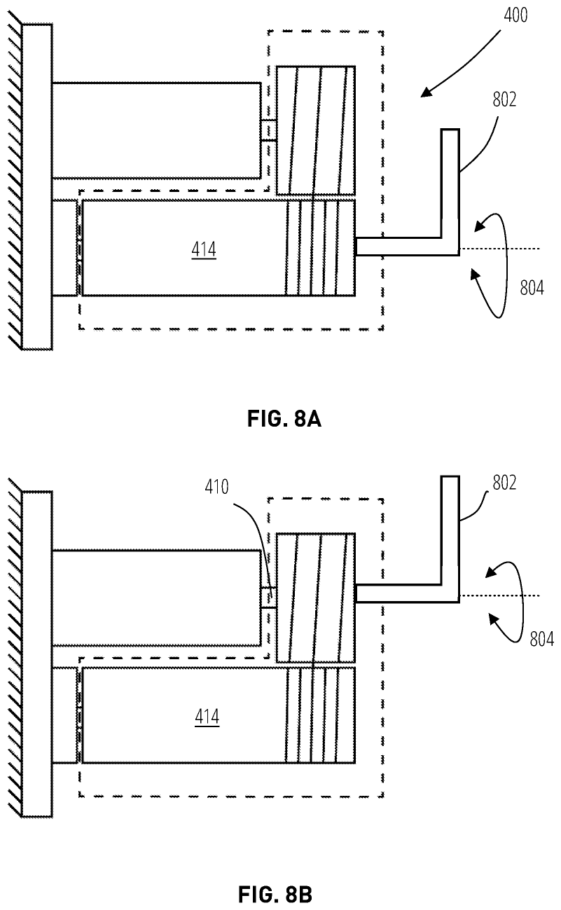

In some embodiments, the torque of the hybrid actuator system may be output on the brake housing (e.g., outrunner brake housing), an example of which is illustrated in FIG. 8A. In this non-limiting example, a joint/lever/handle member 802 is shown being coupled to the brake housing 414 of the system 400 of FIG. 4. The system 400 is thus configured to provide haptic feedback in the form of a controlled torque 804 to the handle member 802. The illustrated shape of handle member 802 is exemplary only and handle member 802 may take any shape or form, without limitation. Other coupling locations may be used as well, for example other embodiments may have the handle member 802 (or joint, lever, etc.) coupled instead to the shaft of the motor (directly or indirectly), as illustrated in FIG. 8B, but more generally any other rotating part of the actuator system may be used to output the torque without limitation.

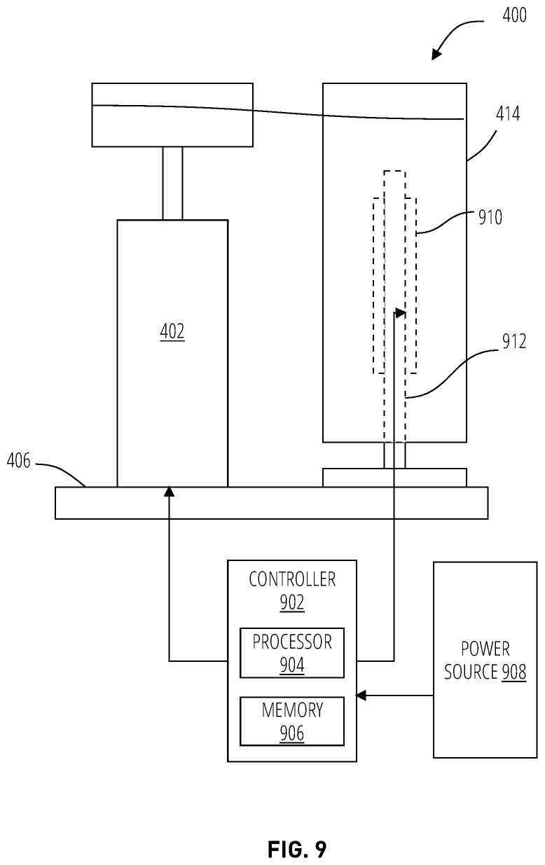

FIG. 9 is a schematic diagram illustrating the parallel hybrid actuator system 400 of FIG. 4 coupled to a controller 902, in accordance with one embodiment. The controller 902 typically comprises a processor 904 coupled to a memory 906 and a power source 908. In this example, which uses a MR braking mechanism as an example only, the controller 902 is operably coupled to the motor 402 and to the braking device 414 so as to activate, modulate or deactivate the motor 402 and/or the magnetic coils 910 coupled to the fixed brake shaft 912. The memory 906 has stored thereon instructions for operating both the motor 402 and the braking device 414 in a coordinated fashion to provides a designated haptic torque feedback. The specific details on how such a controller may be coupled to a motor and a braking mechanism (such as a MR braking mechanism or other) is known to the skilled person in the art and will not be further discussed.

While the examples given above showed the hybrid actuator system comprising a single motor and a single braking device, the skilled person in the art will appreciate that this is for clarity only, and that more than one motor and/or braking device may be coupled in parallel in such fashion, without limitation.

The present disclosure includes systems having processors to provide various functionality to process information, and to determine results based on inputs. Generally, the processing may be achieved with a combination of hardware and software elements. The hardware aspects may include combinations of operatively coupled hardware components including microprocessors, logical circuitry, communication/networking ports, digital filters, memory, or logical circuitry. The processors may be adapted to perform operations specified by a computer-executable code, which may be stored on a computer readable medium.

The steps of the methods described herein may be achieved via an appropriate programmable processing device, embedded processing device or an on-board field programmable gate array (FPGA) or digital signal processor (DSP), that executes software, or stored instructions. In general, physical processors and/or machines employed by embodiments of the present disclosure for any processing or evaluation may include one or more networked or non-networked general purpose computer systems, microprocessors, field programmable gate arrays (FPGA's), digital signal processors (DSP's), micro-controllers, and the like, programmed according to the teachings of the exemplary embodiments discussed above and appreciated by those skilled in the computer and software arts. Appropriate software can be readily prepared by programmers of ordinary skill based on the teachings of the exemplary embodiments, as is appreciated by those skilled in the software arts. In addition, the devices and subsystems of the exemplary embodiments can be implemented by the preparation of application-specific integrated circuits, as is appreciated by those skilled in the electrical arts. Thus, the exemplary embodiments are not limited to any specific combination of hardware circuitry and/or software.

Stored on any one or a combination of computer readable media, the exemplary embodiments of the present invention may include software for controlling the devices and subsystems of the exemplary embodiments, for driving the devices and subsystems of the exemplary embodiments, for processing data and signals, for enabling the devices and subsystems of the exemplary embodiments to interact with a human user or the like. Such software can include, but is not limited to, device drivers, firmware, operating systems, development tools, applications software, and the like. Such computer-readable media further can include the computer program product of an embodiment of the present invention for preforming all or a portion (if processing is distributed) of the processing performed in implementations. Computer code devices of the exemplary embodiments of the present invention can include any suitable interpretable or executable code mechanism, including but not limited to scripts, interpretable programs, dynamic link libraries (DLLs), complete executable programs and the like.

Common forms of computer-readable media may include, for example, magnetic disks, flash memory, RAM, a PROM, an EPROM, a FLASH-EPROM, or any other suitable memory chip or medium from which a computer or processor can read.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A haptic braking device for use in a parallel hybrid actuator system, the haptic braking device comprising:
a fixed elongated shaft member having a first end directly or indirectly affixed to a non-rotating surface, the fixed elongated shaft member comprising a driving member coupled along a length thereof configured to drive a change a rheological property of a damping substance;
a rotatable brake housing, the housing comprising:
an outer lateral surface configured to be rotationally coupled to a motor shaft via a transmission;
an elongated aperture defined within said housing fittingly receiving said shaft member therethrough and configured to allow said housing to rotate around said shaft member; and
one or more channels defined within said housing filled with said damping substance, the channels configured so that the damping substance is in physical contact with the shaft member and the driving member; and
wherein upon said driving member being activated, the change in rheological property on the damping substance causing an increased frictional resistance to a rotational motion of the housing around said shaft member.

2. The haptic braking device of claim 1, wherein said damping substance is a magneto-rheological (MR) fluid, and wherein said driving device comprises:
a magnetic coil configured to, upon said activation, generate a magnetic field through said MR fluid, thereby causing an increase in a viscosity of said MR fluid and increasing said frictional resistance.

3. The haptic braking device of claim 1, wherein said damping substance is an electro-rheological (ER) fluid, and wherein said driver device comprises:
a plurality of spaced-apart electrically conductive parallel plates configured to generate, upon said activation, an electrical field through the ER fluid, thereby causing an increase in a viscosity of said ER fluid and increasing said frictional resistance.

4. The haptic braking device of claim 1, wherein said damping substance is a free-flowing powder of magnetizable particles, and wherein said driving device comprises:
a magnetic coil configured to, upon being activated, generate a magnetic field through said powder of magnetizable particles, thereby making the particles clump along magnetic field lines and increase said frictional resistance.

5. The haptic braking device of claim 1, further comprising:
a power source for providing power to said damping portion upon said activation; and
a controller comprising a processor and a memory, the controller operably coupled to said damping portion and configured to activate or deactivate said damping portion.

6. The haptic braking device of claim 1, wherein said rotatable brake housing is cylindrically shaped.

7. The haptic braking device of claim 6, wherein said transmission is a capstan transmission and wherein said outer lateral surface is configured to be coupled to a cable of said capstan transmission.

8. The haptic braking device of claim 7, wherein said cable of the capstan transmission is further coupled to a capstan drum attached to said motor shaft.

9. The haptic braking device of claim 6, wherein said transmission is a transmission chain, and wherein said outer lateral surface comprises a plurality of outwardly projecting teeth for engaging said chain.

10. The haptic braking device of claim 6, wherein said transmission is a belt and wherein said outer lateral surface comprises a groove or recess for receiving said belt therein.

11. The haptic braking device of claim 1, wherein said shaft member comprises:
an elongated shaft body configured to be received within said elongated aperture; and
an attachment portion coupled to said elongated shaft body and affixed to said non-rotating surface.

12. The haptic braking device of claim 11, wherein said elongated shaft body and said attachment portion form a single piece.

13. The haptic braking device of claim 11, wherein said elongated shaft body can be removably fastened to said attachment portion.

14. A parallel hybrid actuator system for providing haptic feedback, comprising:
a motor affixed to a non-rotating surface at a first location, the motor comprising a motor shaft and configured to, upon activation, drive a rotation of the motor shaft;
a braking device comprising:
a fixed elongated shaft member having a first end directly or indirectly affixed to said non-rotating surface at a second location, the fixed elongated shaft member comprising a driving member coupled along a length thereof configured to drive a change a rheological property of a damping substance;
a rotatable brake housing, the housing comprising:
an elongated aperture defined within said brake housing fittingly receiving said fixed shaft member therethrough and configured to allow said brake housing to rotate around said fixed shaft member; and
one or more channels defined within said housing filled with said damping substance, the channels configured so that the damping substance is in physical contact with the shaft member and the driving member; and
a transmission for rotationally coupling the motor shaft to an outer lateral surface of said rotatable brake housing.

15. The parallel hybrid actuator system of claim 14, further comprising:
a controller comprising a processor and a memory, the controller operably coupled to said motor and to said damping portion of the braking device and configured to control the activation of said motor and said damping portion to provide said haptic feedback.

16. The parallel hybrid actuator system of claim 14, further comprising:
a handle member rotationally coupled to one of: the motor shaft, the transmission, or the rotatable break housing.

17. The parallel hybrid actuator system of claim 16, wherein said handle member is coupled to the rotatable brake housing.

18. The parallel hybrid actuator system of claim 16, wherein said handle member is coupled to the motor shaft.

19. The parallel hybrid actuator system of claim 14, wherein the transmission is a capstan transmission coupled to the motor shaft at one end thereof, and coupled to the brake housing at a second end thereof.

20. The parallel hybrid actuator system of claim 14, wherein said motor is a first motor of a plurality of motors, and said braking device is a first braking device of plurality of devices; and
wherein each of said plurality of motors and said plurality of braking devices are rotationally coupled in parallel to one another via said transmission.
